(19) United States
(12) Patent Application Publication
(10) Pub. No.: US 2023/0407699 A1
(43) Pub. Date: Dec. 21, 2023

(54) OUTSWING ADA SILL

(71) Applicant: Endura Products, LLC, Colfax, NC (US)

(72) Inventor: Adam Kendall, Burlington, NC (US)

(73) Assignee: Endura Products, LLC, Colfax, NC (US)

(21) Appl. No.: 17/842,984

(22) Filed: Jun. 17, 2022

(51) Int. Cl. E06B 1/70; E06B 1/60

(52) U.S. Cl. CPC E06B 1/70; E06B 1/6092

(57) ABSTRACT

An outswing sill that is ADA compliant includes a top surface that extends from an outside edge that is configured to be positioned on an exterior side of a door when the door is in a closed configuration to an inside edge that is configured to be positioned on an inner side of the door when the door is in the closed configuration. The top surface has a sealing ramp that increases in height in a direction from the outside edge towards an inside edge. The sealing ramp is configured to be engaged by a door sweep of the door to form a seal with the door sweep when the door is in the closed configuration. The entire top surface having vertical rises of 0.25 inches or less, a total height of 0.5 inches or less, and having a rise:run slope of 1:2 or less.

### BACKGROUND

### 1. Technical Field

The present disclosure relates to door sills and, more specifically, to outswing ADA compliant door sills.

### 2. Discussion of Related Art

Outswing doors are hinged such that the door swings outward when opened. Typically, an outswing door includes a sill 510 that includes a vertical dam 520 with a weather strip 530 applied to the vertical dam 520 as shown in FIG. 1. When closed, a door engages the weather strip 530 to form a seal at the vertical dam 520. In outswing door applications, a door typically does not include a sweep as a seal is formed with the vertical dam 520 and the weather strip 530 applied thereto.

The American with Disabilities Act (ADA) has requirements that limit a vertical rise of a door sill. Currently the ADA restricts vertical rises to 0.25 inches and a total sill height to 0.5 inches. Further, the ADA restricts a slope of a bevel of the sill to not steeper than 1:2 rise:run ratio. It has been difficult to provide a sill with the typical outswing configuration as shown in FIG. 1 to meet the requirements of the ADA while providing a seal that meets sealing requirements for an outswing sill. Specifically, the vertical dam 520 and weather strip 530 have a vertical rise greater than 0.25 inches to provide a sufficient sealing surface for the door.

### SUMMARY

This disclosure relates generally to an outswing door sill that meets the requirements of the ADA. Specifically, the outswing door sill disclosed herein does not have a vertical rise greater than 0.25 inches and has a total height of 0.5 inches or less. In addition, a slope of bevels of a top surface of the disclosed outswing door sill is 1:2 or less. The outswing door sill may include a sealing ramp that is engaged by a door sweep to form a seal with the sill. In some embodiments, when the disclosed outswing door sill is exposed to increased atmospheric pressure, the sealing surfaces may fit tighter (e.g., increased seal strength).

In an embodiment of the present disclosure, an outswing sill includes a top surface that extends from an outside edge that is configured to be positioned on an exterior side of a door when the door is in a closed configuration to an inside edge that is configured to be positioned on an inner side of the door when the door is in the closed configuration. The top surface has a sealing ram that increases in height in a direction from the outside edge towards an inside edge. The sealing ramp is configured to be engaged by a door sweep of the door to form a seal with the door sweep when the door is in the closed configuration. The entire top surface having vertical rises of 0.25 inches or less and a total height of 0.5 inches or less.

In embodiments, the outswing sill includes a first segment, a second segment, and a connector disposed between the first segment and the second segment. The first segment may extend from the outside edge to the connector and the second segment may extend from the connector to the inside edge. The first segment, the second segment, and the connector may each form a portion of the top surface.

In some embodiments, the first segment is configured to be positioned under the door in the closed configuration, the first segment may include the sealing ramp. The second segment may connect to the connector at a height greater than where the first segment connects to the connector.

In certain embodiments, the second segment has a height adjacent the connector greater than 0.25 inches and a ramp adjacent the inside edge such that a height of the second segment at the inside edge is 0.25 inches or less. The connector may provide a thermal break between the first segment and the second segment. The connector may be formed of a thermally insulative material.

In particular embodiments, the sealing ramp is configured such that the seal between the door sweep and the sealing ramp increases as the door sweep moves towards the inside edge. The outswing sill may include a sealing strip that underlies the sealing ramp. The sealing strip may be secured to an underside of the sill. The outswing sill may include a plurality of legs that extend from an underside of the outswing sill to support the top surface.

In another embodiment of the present disclosure, a door frame assembly includes a door frame, a first jamb boot, a second jamb boot, and an outswing sill disposed between the first jamb boot and the second jamb boot. The first jamb boot and the second jamb boot each support a bottom of the door frame. The outswing sill having a first side edge that is supported by the first jamb boot and a second side edge that is supported by the second jamb boot. The outswing sill has an outside edge and an inside edge that extend between the first side edge and the second side edge. The outside edge is configured to be positioned on an exterior side of a door when the door is in a closed configuration and the inside edge configured to be positioned on an inner side of the door when the door is in the closed configuration. The outswing sill has a top surface that includes a sealing ramp which increases in height in a direction from the outside edge towards the inside edge. The sealing ramp configured to be engaged by a door sweep of the door to form a seal with the door sweep when the door is in the closed configuration. The entire top surface has vertical rises of 0.25 inches or less and a total height of 0.5 inches or less.

In embodiments, the outswing sill includes a first segment, a second segment, and a connector. The first segment may extend from the outside edge of the connector and the second segment may extend from the connector to the inside edge. The first jamb boot may include an exterior surface and an interior surface opposite the exterior surface. The first jamb boot may include a stop surface that is parallel to and is disposed between the exterior surface and the interior surface. The stop surface may be configured to be engaged by an interior face of the door in the closed configuration. The stop surface may be positioned interior of the connector. The stop surface may cover a portion of the outswing sill.

In some embodiments, the first jamb boot may include a support surface that extends between the exterior surface and the interior surface. The support surface may be engaged with the first side edge of the outswing sill. The support surface may define an opening that is configured to receive a support that is engaged by the outswing sill to support the top surface of the outswing sill.

In certain embodiments, the sealing ramp is configured to increase a tightness of the seal as the door sweep moves towards the inside edge.

In another embodiment of the present disclosure, an outswing sill has an outside edge an inside edge including a first segment, a second segment, and a connector. The first segment extends from the outside edge towards the inside edge. The first segment includes a sealing ramp that increases in height as the sealing ramp extends towards the inside edge. The second segment extends from the inside edge towards the outside edge. The connector is disposed between and interconnecting the first segment and the second segment. Each of the first segment, the second segment, and the connector forming a portion of a top surface of the outswing sill. The entire top surface having vertical rises of 0.25 inches or less and a total height of 0.5 inches or less.

In embodiments, the connector forms a thermal break between the first segment and the second segment. The sealing ramp may be configured to be engaged by a door sweep to form a seal.

Further, to the extent consistent, any of the embodiments or aspects described herein may be used in conjunction with any or all of the other embodiments or aspects described herein.

### BRIEF DESCRIPTION OF THE DRAWINGS

Various aspects of the present disclosure are described hereinbelow with reference to the drawings, which are incorporated in and constitute a part of this specification, wherein:

FIG. 1 is a side cutaway view of a prior art outswing door sill;

FIG. 2 is a side cutaway view of an outswing door sill provided in accordance with an embodiment of the present disclosure;

FIG. 3 is a side cutaway view of the outswing door sill of FIG. 1 with a door sweep engaged with the outswing door sill;

FIG. 4 is a top, perspective view of a door system provided in accordance with an embodiment of the present disclosure including an outswing door sill, a jamb boot, and a door frame

FIG. 5 is perspective view of the jamb boot of FIG. 4;

FIG. 6 is a top, perspective view of the outswing door sill of FIG. 1 engaged with the jamb boot of FIG. 5;

FIG. 7 is a bottom, perspective view of the jamb boot and the outswing door sill of FIG. 5;

FIG. 8 is a top, perspective view of another outswing door sill provided in accordance with an embodiment of the present disclosure; and

FIG. 9 is a side view of another door system provided in accordance with an embodiment of the present disclosure including the outswing door sill of FIG. 8.

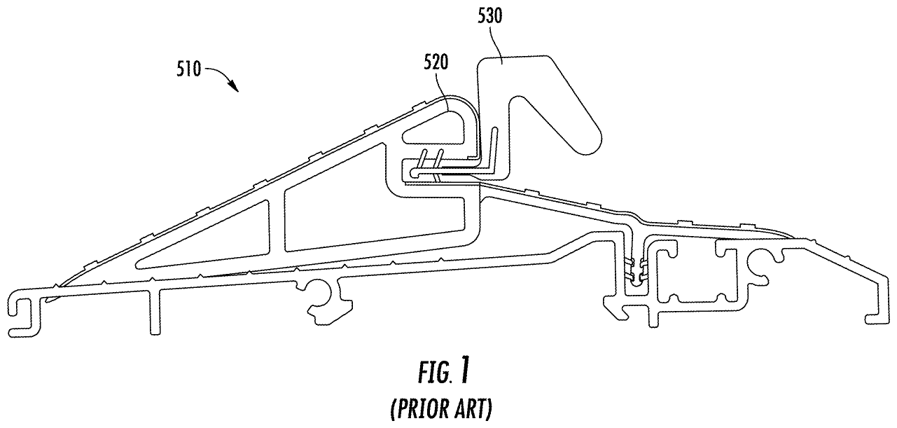

### DETAILED DESCRIPTION

The present disclosure will now be described more fully hereinafter with reference to example embodiments thereof with reference to the drawings in which like reference numerals designate identical or corresponding elements in each of the several views. These example embodiments are described so that this disclosure will be thorough and complete, and will fully convey the scope of the disclosure to those skilled in the art. Features from one embodiment or aspect can be combined with features from any other embodiment or aspect in any appropriate combination. For example, any individual or collective features of method aspects or embodiments can be applied to apparatus, product, or component aspects or embodiments and vice versa. The disclosure may be embodied in many different forms and should not be construed as limited to the embodiments set forth herein; rather, these embodiments are provided so that this disclosure will satisfy applicable legal requirements. As used in the specification and the appended claims, the singular forms “a,” “an,” “the,” and the like include plural referents unless the context clearly dictates otherwise. In addition, while reference may be made herein to quantitative measures, values, geometric relationships or the like, unless otherwise stated, any one or more if not all of these may be absolute or approximate to account for acceptable variations that may occur, such as those due to manufacturing or engineering tolerances or the like. As used herein, the term “vertical rise” refers to a rise where the slope is greater than 1:2 rise:run ratio.

This disclosure is generally directed to ADA compliant door sills and in particular, to ADA compliant outswing door sills. As such, the door sills disclosed herein do not include vertical rises greater than 0.25 inches, have a total height of 0.5 or less, and have bevels with a rise:run ratio of 1:2 or less.

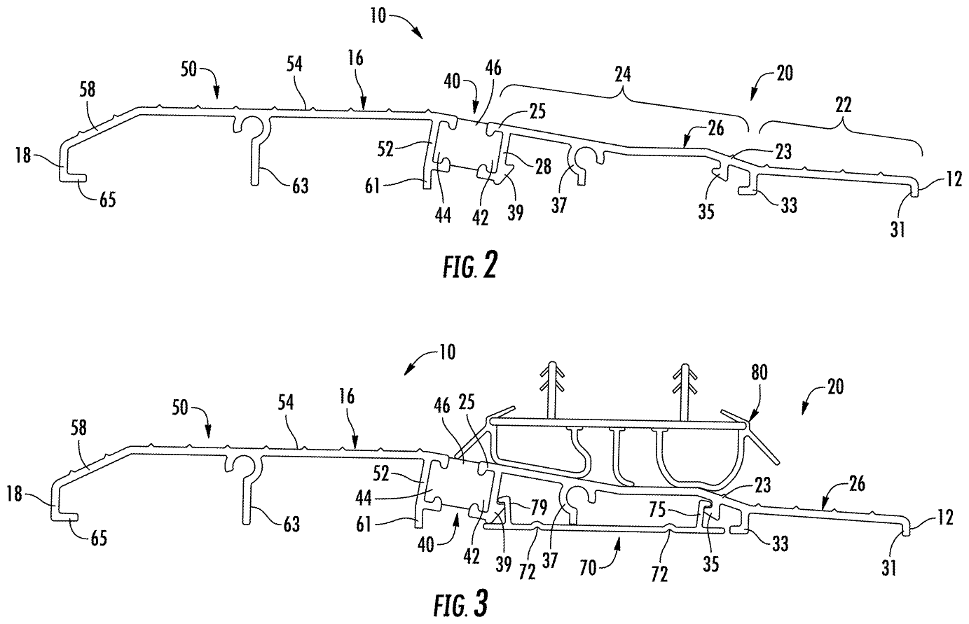

Referring now to FIG. 2, a cross-section of an outswing door sill is provided in accordance with an embodiment of the present disclosure and is referred to generally as sill 10. The sill 10 has an outside edge 12 that is configured to be on an outside of a closure such as a door and an inside edge 18 that is configured to be on an inside of the closure. The sill 10 includes a top surface 16 that is configured to form a ramp and a portion of a seal for closure. The sill 10 includes an outer segment 20, an inner segment 50, and a connector 40 that is disposed between the outer segment 20 and the inner segment 50.

The outer segment 20, the inner segment 50, and the connector 40 may be formed by molding or extrusion. For example, the outer segment 20, the inner segment 50, or the connector may be formed as an extrusion and cut to a desired length based on a width of a closure. In some embodiments, the outer segment 20, the inner segment 50, or the connector 40 may be formed as a continuous extrusion.

The outer segment 20 and/or the inner segment 50 may be formed of a thermally conductive material including, but not limited to, aluminum or steel. In some embodiments, the connector 40 is formed of an insulative material that provides a thermal break between the outer segment 20 and the inner segment 50. For example, the connector 40 may be formed of a thermoplastic, a thermoset, or rubber to form a seal with and a thermal break between the outer segment 20 and the inner segment 450. The connector 40 includes an outer ear 42 and an inner ear 44. As shown, the connector 40 is supported above a surface or threshold underlying the sill such that the connector 40 may not contact the surface or threshold. The connector 40 may include a top shelf or extension 46 that forms a portion of the top surface 16 of the sill 10. In certain embodiments, the connector 40 may be formed of a thermally conductive material similar to the outer segment 20 and the inner segment 50.

In some embodiments, the outer segment 20 and the inner segment 50 may be of integral construction with one another such that there is no connector 40 between the outer segment 20 and the inner segment 50. In particular embodiments, the outer segment 20 and the inner segment 50 may be formed of unitary or monolithic construction. In some embodiments, the outer segment 20 and the inner segment 50 may be constructed of a material having a low thermal conductivity including a thermoplastic or a thermoset such that a thermal break is not necessary between the outer segment 20 and the inner segment 50. In certain embodiments when the outer segment 20 and the inner segment 50 are formed of a thermally conductive material, the outer segment 20 and the inner segment 50 may be of integral construction without a thermal break therebetween.

The outer segment 20 is configured to be positioned on the outside of a closure and forms the outside edge 12 of the sill 10. The outer segment 20 includes an outer slot 28 that is configured to engage and form a connection with the outer ear 42 of the connector 40. The outer segment 20 includes an upper surface 26 that forms a portion of the top surface 16 of the sill 10. The upper surface 26 extends from the outside edge 12 to the outer slot 28 to form a first or outer ramp 22 adjacent the outside edge 12 and a second or sealing ramp 24 adjacent the outer slot 28. The upper surface 26 forms a low ramp that gradually increases in height from the outside edge 12 to the outer slot 28. The rise:run of the upper surface 26 is 1:2 or less. The upper surface 26 has a height of less than 0.25 inches adjacent the outside edge 12 and may have height in a range of 0.0625 inches to 0.25 inches, e.g., 0.125 inches. The upper surface 26 has a height of less than 0.5 inches adjacent the outer slot 28 and may have a height in a range of 0.25 inches to 0.5 inches, e.g., 0.4375 inches.

As shown in FIG. 3, the sealing ramp 24 is configured to be engaged by a door sweep 80 of a door when the door is in a closed position. The sealing ramp 24 is inclined from a leading end 23 to a trailing end 25 thereof. The incline of the sealing ramp 24 may enhance a seal formed between the door sweep 80 and the sealing ramp 24. When the pressure on an outside of a door is greater than the pressure on an inside of a door, the door sweep 80 is pressed into the sealing ramp 24 such that a seal formed between the door sweep 80 and the sealing ramp 24 is enhanced.

The outer segment 20 may include one or more supports that extend from an underside thereof. As shown, from the outside edge 12 to the outer slot 28, the outer segment 20 includes a first or leading leg 31, a second leg 33, a first tab 35, a third leg 37, and a fourth or trailing leg 39. The first, second, third, and fourth legs 31, 33, 37, 39 may be configured to contact a threshold to support the outer segment 20 of the sill 10. In some embodiments, one or more of the legs 31, 33, 37, 39 and the first tab 35 may engage a sealing strip 70 that underlies the outer segment 20.

The outer segment 20 of the sill 10 may be secured to a sealing strip 70 that is secured to a threshold. The sealing strip 70 may be configured to underlie a door when the door is in a closed position. The sealing strip 70 may be adhered, bonded, or secured to the threshold with one or more fasteners (not shown). The sealing strip 70 may include channels 72 that receive caulk to form a seal between the threshold and the sill 10. The sealing strip 70 may include a first or leading prong 75 and a second or trailing prong 79. The leading prong 75 may be engaged by the first tab 35 of the outer segment 20 to secure the outer segment 20 to the sealing strip 70. The trailing prong 79 may engage the trailing leg 39 of the outer segment to secure the outer segment 20 to the sealing strip 70. In embodiments, the third leg 37 and/or the trailing leg 39 may be supported on the sealing strip 70.

Continuing to refer to FIGS. 2 and 3, the inner segment 50 includes an inner slot 52 that receives the inner ear 44 of the connector 40 to secure the inner segment 50 to the connector The inner segment 50 includes an upper surface 54 that forms a portion of the top surface 16 of the sill 10. The upper surface 54 may be supported at a height of 0.5 inches or less such that a total height of the sill 10 is less than or equal to 0.5 inches. The upper surface 54 may be substantially level from the connector 40 to a trailing ramp 58 that is adjacent the inside edge 18 of the sill 10. In some embodiments, the upper surface 54 may increase in height from the top surface 46 of the connector 40. The trailing ramp 58 of the inner segment 50 may decrease a height of the upper surface 54 from above 0.25 inches to a height of 0.25 inches or less at the inside edge 18 of the sill 10. It is noted that the upper surface 54 has a slope of 1:2 rise:run ratio or less.

The inner segment 50 may include a first support 61, a second support 63, and a third support 65 that support the inner segment 50 above a surface or threshold. The first support 61 may be adjacent the inner slot 52 to support the inner segment 50 adjacent the connector 40. The second support 63 may be positioned adjacent a midpoint of the inner segment 50 to support the upper surface 54. The third support 65 may be positioned at the inside edge 18 of the sill 10 to support the inside edge 18.

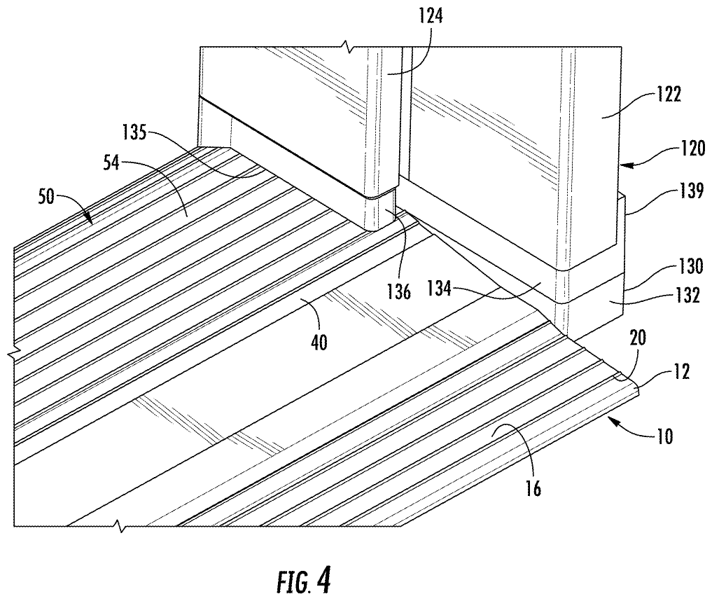

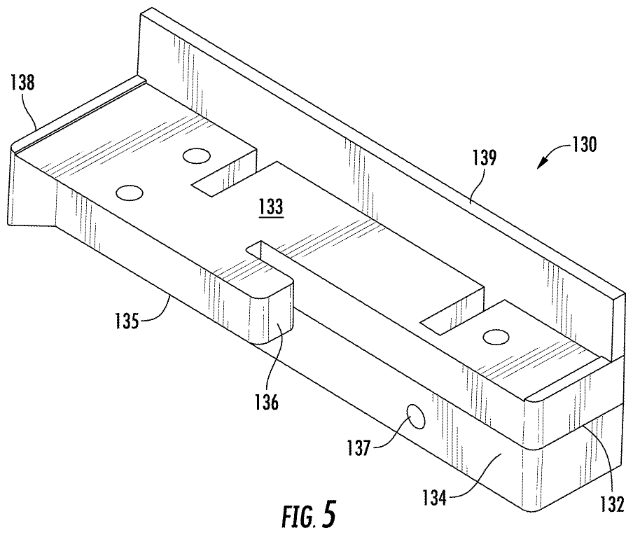

With reference to FIG. 4, a door frame assembly 110 is provided in accordance with embodiments of the present disclosure. The door frame assembly 110 may include the sill 10, jamb boots 130, and a door frame 120. A jamb boot 130 may be positioned on each end of the sill 10 to seal and support the end of the sill 10. The jamb boots 130 may receive a lower end of a door frame 120 to support the door frame 120 above the surface or threshold. The door frame 120 is an outswing door frame with an outer face 122 and a stop face 124. When a door is in the closed position, the door is configured to contact the stop face 124 and be positioned between the outer face 122 and the stop face 124. The stop face 124 may be positioned interior of the connector 40. In some embodiments, the stop face 124 may include a weather strip (not explicitly shown) secured thereto that is compressed by the door in the closed position to form a seal between the stop face 124 and the door.

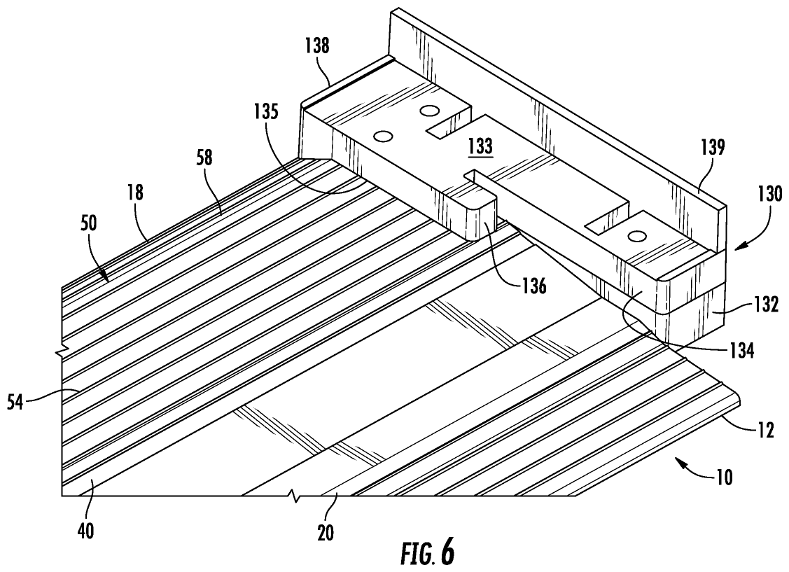

With additional reference to FIGS. 5-7, a jamb boot 130 includes an outer wall 132, an inner wall 138, a sill support wall 134, and a side wall 139. The jamb boot 130 shown in FIGS. 5-7 is a right jamb boot that is similar to a left jamb boot on the opposite side of the door frame assembly 110 that is a mirror image of the right jamb boot shown. The outer wall 132 forms the outer end of the jam boot 130 and may be positioned interior of the outside edge 12 of the sill 10 as shown in FIG. 4 such that the sill 10 may extend outside beyond the jamb boot 130. The jamb boot 130 defines a support surface 133 that receives a bottom of the door frame 120 to support the door frame 120 above the sill 10. The side wall 139 may extend upward from an outer side edge of the jamb boot 130 and may position the door frame 120 relative to the support surface 133. The jamb boot 130 may space the bottom of the door frame 120 from the surface or threshold to prevent direct contact of the door frame 120 with the surface. In some embodiments, the door frame 120 may be made of a wood product that may be susceptible to rot and may wick moisture from the surface upward into the door frame 120. In such embodiments, spacing the bottom of the door frame 120 from the surface may prevent rot of the door frame 120.

The sill support wall 134 may define a portion of an inner side edge of the jamb boot 130 that faces the sill 10. A portion of the support surface 133 may extend from the sill support wall 134 to be positioned above the top surface 16 of the sill 10. Specifically, a lower surface 135 that is opposite the support surface 133 may contact the upper surface 54 of the inner segment 50 of the sill 10. As shown, an inner extremity of the lower surface 135 may conform to the trailing ramp 58 of the inner segment 50. A junction where the sill 10 meets the sill support wall 134 may be sealed such that a side of the sill 10 is sealed at the jamb boot 130. The seal between the sill 10 and the jamb boot 130 may prevent water from infiltrating around the side of the sill 10. In some embodiments, the seal between the side of the sill 10 and the jamb boot 130 may be formed with caulk or a gasket material. In certain embodiments, the seal may be formed with an adhesive gasket that is sized and dimensioned to seal the side of the sill 10 at the jamb boot 130.

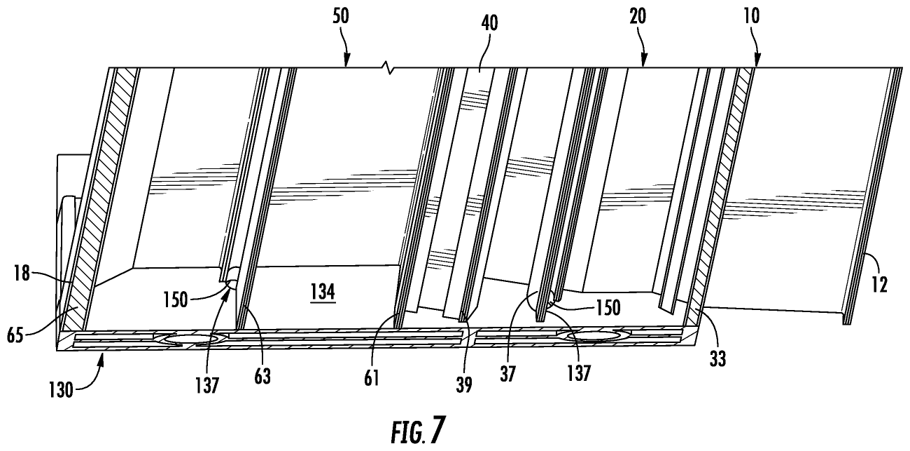

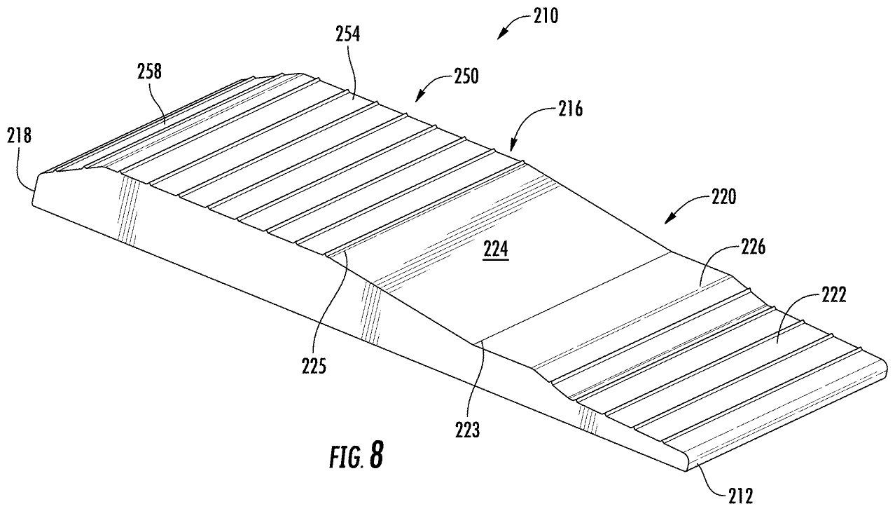

The sill support wall 134 may define one or more openings 137 that receive supports for the sill 10. With particular reference to FIG. 7, the openings 137 may receive a peg 150 that extends partially into a leg or support of the sill 10. As shown, a peg 150 received in one opening 137 is received by the third leg 37 of the outer segment 20 and a peg 150 received in another opening 137 is received by the second support 63 of the inner segment 50. In certain embodiments, the openings 137 receive or support a rail that extends the width of the sill 10 and is received in a respective leg or support of the sill 10 in a manner similar to the pegs 150 detailed above. In certain embodiments, the openings 137 are through holes that extend through the jamb boot 130 and are sized and dimensioned to allow a fastener 150 to pass therethrough and into the respective leg 37, 63 of the sill 10. In some embodiments, the fastener 150 is a screw that is threaded into the respective leg 37, 63 of the sill 10. The fastener 150 may secure the jamb boot 130 to the sill 10 and/or compress a seal between the jamb boot 130 and the sill 10.

Referring now to FIG. 8, a cross-section of an outswing door sill is provided in accordance with an embodiment of the present disclosure and is referred to generally as sill 210. Sill 210 is detailed below with similar elements to elements of sill 10 represented with a similar label with a “2” preceding the previous label associated with the element of sill 10. For reasons of brevity, only the differences with sill 10 will be detailed below.

The sill 210 include includes a top surface 216 that is configured to form a ramp and a portion of a seal. The sill 210 includes an outer segment 220 and an inner segment 250. As shown, the outer segment 220 and the inner segment 250 are monolithically or unitarily formed with one another. For example, the outer segment 220 and the inner segment 250 may be formed during a single extrusion process or a single molding process. The sill 210 may be formed of a thermally conductive material, e.g., aluminum or steel, or may be formed of a thermally insulative material, e.g., a thermoset or thermoplastic. In some embodiments, the sill 210 may be extruded or molded in a length longer than desired and cut to a desired length based on a width of a closure. In some embodiments, sill 210 be formed as a continuous extrusion.

The outer segment 220 is configured to be positioned on the outside of a closure and forms the outside edge 212 of the sill 210. The outer segment 220 includes an upper surface 226 that forms a portion of the top surface 216 of the sill 210. The upper surface 226 extends from the outside edge 212 to a first or outer ramp 222 adjacent the outside edge 212 and a second or sealing ramp 224 inward from the outer ramp 222. The upper surface 226 forms a low ramp that gradually increases in height from the outside edge 212 to the inner segment 220. The rise:run of the upper surface 226 is 1:2 or less. The upper surface 226 has a height of less than 0.25 inches adjacent the outside edge 212 and may have height in a range of 0.0625 inches to 0.25 inches, e.g., 0.125 inches. The upper surface 226 has a height of less than 0.5 inches adjacent the inner segment 250 and may have a height in a range of 0.25 inches to 0.5 inches, e.g., 0.4375 inches.

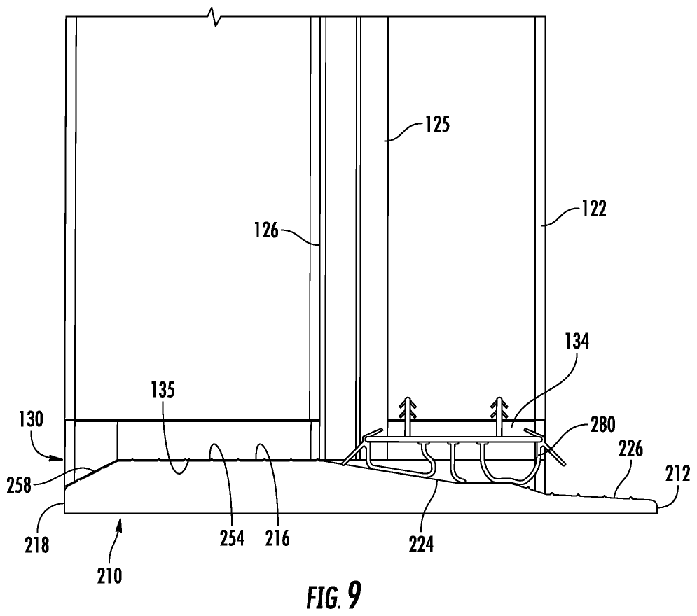

As shown in FIG. 9, the sealing ramp 224 is configured to be engaged by a door sweep 280 of a door when the door is in a closed position. The sealing ramp 224 is inclined from a leading end 223 to a trailing end 225 thereof. The incline of the sealing ramp 224 may enhance a seal formed between the door sweep 280 and the sealing ramp 224. When the pressure on an outside of a door is greater than the pressure on an inside of a door, the door sweep 280 is pressed into the sealing ramp 224 such that a seal formed between the door sweep 280 and the sealing ramp 224 is enhanced.

Continuing to refer to FIG. 8, the inner segment 250 extends from the sealing ramp 224 to an inside edge 218 of the sill 210. The inner segment 250 includes an upper surface 254 that forms a portion of the top surface 216 of the sill 210. The upper surface 254 may be supported at a height of 0.5 inches or less such that a total height of the sill 210 is less than or equal to 0.5 inches. The upper surface 254 may be substantially level from the sealing ramp 224 to a trailing ramp 258 that is adjacent the inside edge 218 of the sill 210. In some embodiments, the upper surface 254 may increase in height from the sealing ramp 224. The trailing ramp 258 of the inner segment 250 may decrease a height of the upper surface 254 from above 0.25 inches to a height of 0.25 inches or less at the inside edge 218 of the sill 210. It is noted that the upper surface 54 has a slope of 1:2 rise:run ratio or less.

Although not explicitly shown, the outer segment 220 and the inner segment 250 may include one or more legs or supports that extend from an underside thereof similar to the outer segment 20 and the inner segment 50 detailed above. In some embodiments, one or more of the legs may engage a sealing strip that underlies a portion of the sill 210.

With reference to FIG. 9, the door frame assembly 110 may include the sill 210, jamb boots 130, and the door frame 120. The jamb boot 130 may be positioned on each end of the sill 210 to seal and support the ends of the sill 210. When a door is in the closed position, the door is configured to contact the stop face 124 and be positioned between the outer face 122 and the stop face 124. As shown, the stop face 124 includes a weather strip 125 secured thereto that is compressed by the door in the closed position to form a seal between the stop face 124 and the door.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

1. An outswing sill comprising:
a top surface that extends from an outside edge configured to be positioned on an exterior side of a door when the door is in a closed configuration to an inside edge configured to be positioned on an interior side of the door when the door is in the closed configuration, the top surface having a sealing ramp spaced apart from the outside edge, the sealing ramp increasing in height in a direction from the outside edge towards the inside edge, the sealing ramp configured to be engaged by a door sweep of the door to form a seal with the door sweep when the door is in the closed configuration, any vertical rises of the top surface being 0.25 inches or less, the outswing sill having a total height of less than or equal to 0.5 inches.

2. The outswing sill according to claim 1, further comprising a first segment, a second segment, and a connector, the first segment extending from the outside edge to the connector, the second segment extending from the connector to the inside edge.

3. The outswing sill according to claim 2, wherein each of the first segment, the second segment, and the connector forms a portion of the top surface.

4. The outswing sill according to claim 2, wherein the first segment is configured to be positioned under the door in the closed configuration, the first segment including the sealing ramp.

5. The outswing sill according to claim 2, wherein the second segment has a height adjacent the connector greater than 0.25 inches and a ramp adjacent the inside edge such that a height of the second segment at the inside edge is 0.25 inches or less.

6. The outswing sill according to claim 2, wherein the connector provides a thermal break between the first segment and the second segment.

7. The outswing sill according to claim 1, wherein the entire outswing sill is of monolithic construction.

8. The outswing sill according to claim 1, wherein the sealing ramp is configured such that the seal between the door sweep and the sealing ramp increases as the door sweep moves towards the inside edge.

9. The outswing sill according to claim 1, further comprising a sealing strip underlying the sealing ramp, the sealing strip secured to an underside of the sill.

10. The outswing sill according to claim 1, further comprising a plurality of legs extending from an underside of the outswing sill to support the top surface.

11. A door frame assembly comprising:
a door frame;
a first jamb boot supporting a bottom of a first side of the door frame;
a second jamb boot supporting a bottom of a second side of the door frame; and
an outswing sill disposed between the first jamb boot and the second jamb boot with the first jamb boot supporting a first side edge of the outswing sill and the second jamb boot supporting a second side edge of the outswing sill opposite the first side edge, the outswing sill having an outside edge and an inside edge that extend between the first side edge and the second side edge, the outside edge configured to be positioned on an exterior side of a door when the door is in a closed configuration and the inside edge configured to be positioned on an interior side of the door when the door is in the closed configuration, the outswing sill having a top surface that includes a sealing ramp which increases in height in a direction from the outside edge towards the inside edge, the sealing ramp having a first portion having a first slope and a second portion having a second slope greater than the first slope, the first portion and the second portion of the sealing ramp configured to be engaged by a door sweep of the door to form a seal with the door sweep when the door is in the closed configuration, any vertical rises of the top surface being 0.25 inches or less, the outswing sill having a total height of less than or equal to 0.5 inches.

12. The door frame assembly according to claim 11, wherein the outswing sill comprises a first segment, a second segment, and a connector, the first segment extending from the outside edge to the connector, the second segment extending from the connector to the inside edge.

13. The door frame assembly according to claim 12, wherein the first jamb boot includes an exterior surface and an interior surface opposite the exterior surface, the first jamb boot further comprising a stop surface parallel to and disposed between the exterior surface and the interior surface, the stop surface configured to be engaged by an interior face of the door in the closed configuration.

14. The door frame assembly according to claim 13, wherein the stop surface is positioned in the interior direction from the connector.

15. The door frame assembly according to claim 13, wherein the stop surface covers a portion of the outswing sill.

16. The door frame assembly according to claim 13, wherein the first jamb boot includes a support wall that extends between the exterior surface and interior surface, the support wall engaged with the first side edge of the outswing sill, the support wall defining an opening configured to receive a support that is engaged by the outswing sill to support the top surface of the outswing sill.

17. The door frame assembly according to claim 11, wherein the sealing ramp is configured to increase a tightness of the seal as the door sweep moves towards the inside edge.

18. An outswing sill having an outside edge and an inside edge, the outswing sill comprising:
a first segment that extends from the outside edge towards the inside edge, the first segment including a sealing ramp that increases in height as the sealing ramp extends towards the inside edge, the sealing ramp having a leading end and a trailing end, the leading end spaced apart from the outside edge and positioned between the trailing end and the outside edge, the leading end of the sealing ramp having a greater slope than the first segment between the leading end and the outside edge;
a second segment that extends from the inside edge towards the outside edge; and
a connector disposed between and interconnecting the first segment and the second segment, each of the first segment, the second segment, and the connector forming a portion of a top surface of the outswing sill, any vertical rises of the top surface being 0.25 inches or less, the outswing sill having a total height of less than or equal to 0.5 inches.

19. The outswing sill according to claim 18, wherein the connector forms a thermal break between the first segment and the second segment.

20. The outswing sill according to claim 18, wherein the sealing ramp is configured to be engaged by a door sweep to form a seal.
